(19) United States
(12) Patent Application Publication
(10) Pub. No.: US 2002/0062377 A1
(43) Pub. Date: May 23, 2002

(54) Scalable directory, master and slave server based architecture for hosting application services

(76) Inventors: Matthew F. Hillman, Seattle, WA (US); Christopher O. Peterson, Seattle, WA (US); John Y. Geer, Seattle, WA (US)

Correspondence Address: COLUMBIA IP LAW GROUP, PC, 10260 SW GREENBURG ROAD, SUITE 820, PORTLAND, OR, 97223, US

(21) Appl. No.: 09/811,226

(22) Filed: Mar. 16, 2001

Related U.S. Application Data
(60) Provisional application No. 60/252,677, filed on Nov. 20, 2000.

(51) Int. Cl. G06F 15/16

(52) U.S. Cl. 709/227; 709/208

(57) ABSTRACT

A number of directory servers non-exclusively engage a first plurality of servers to serve as master servers for hosting one or more application services, and a second plurality of servers to serve as slave servers for facilitating clients accesses to the one or more hosted application services. During operation, the directory servers receiving requests from clients to access a selected one or selected ones of the one or more hosted application services. In response, the directory servers select and assign selected ones of their non-exclusively engaged master servers to host the one or more accessed application services as well as select and assign selected ones of their engaged slave servers to facilitate the clients to access the one or more hosted application services. In one embodiment, the hosted application service is a hosted Internet Talk Radio System and its hosted multi-party talk radio shows.

### RELATED APPLICATION

This application is a non-provisional application of the earlier filed provisional application No. 60/252,677, filed on Nov. 20, 2000, and claims priority to the earlier filed '677 provisional application, whose specification is hereby fully incorporated by reference.

### BACKGROUND OF THE INVENTION

1. Field of the Invention

The present invention relates to the field of hosting application services. More specifically, the present invention relates to the issue of hosting application services in a scalable manner to allow the hosting resources to be gradually, but easily added, as the services, instantiations and/or user bases of the services increase. The present invention has particular application to hosted multiparty packet based talk radio shows (commonly known as hosted Internet Talk Radio).

2. Background Information

With advances in integrated circuit, microprocessor, networking and communication technologies, increasing number of devices, in particular, digital computing devices, are being networked together. Devices are often first coupled to a local area network, such as an Ethernet based office/home network. In turn the local area networks are interconnected together through wide area networks, such as ATM networks, Frame Relays, and the like. Of particular notoriety is the TCP/IP based global inter-networks, the Internet.

As a result this trend of increased connectivity, increasing number of applications that are network dependent are being deployed. Examples of these network dependent applications include but are not limited to, email, net-based telephony, world wide web, various types of e-commerce and Internet Talk Radio Shows. An “Internet Talk Radio Show” is an online form of communication or entertainment in which a host, using his computer, speakers, and a microphone, broadcasts an audio show to a variety of listeners over the Internet, who listen to the show through their computer and speakers, and can interact with the host through a microphone. The intended experience for the participants is to be similar to conventional terrestrial talk radio, however the technology involved bears no relationship to the technology of terrestrial radio. Further, increasing number of software applications that were traditionally licensed or distributed through discrete distribution medium, such as diskettes, CDROMs and the like, are being distributed online or offered as web based applications, through private intranets or public networks like the Internet.

The increased popularity of network based applications and offering of traditional software applications as application services have in turn led to the emergence of application service providers who host application services for their developers, to relieve the developers from having to maintain and operate the underlying infrastructure. A critical issue to the success of hosting application services is the ability of the application service providers to limit the deployment of the resources required to host the application services, and to gradually grow these resources as the services, the instantiations and/or user bases of the services expand. However, the architecture must allow the newly required resources to be easily integrated with the deployed resources, preferably in a manner that is transparent to the users of the hosted application services. Accordingly, a highly flexible and scalable architecture to host application services is desired.

### SUMMARY OF THE INVENTION

A number of directory servers non-exclusively engage a first plurality of servers to serve as master servers for hosting one or more application services, and a second plurality of servers to serve as slave servers for facilitating clients accesses to the one or more hosted application services. During operation, the directory servers receive requests from clients to access a selected one or selected ones of the application services. In response, the directory servers select and assign selected ones of their non-exclusively engaged master servers to host the one or more accessed application services as well as select and assign selected ones of their non-exclusively engaged slave servers to facilitate the clients to access the one or more hosted application services.

In one embodiment, the selections and assignments of master and slave servers are performed in accordance with a number of metrics that reflect the ability of the master and slave servers to further undertake hosting of additional instantiation of the application services or additional application services, and facilitating accesses to the hosted application services, in view of the hosting and facilitating already undertaken. In one embodiment, the directory server periodically polls their non-exclusively engaged master and slave servers for operational information related to these decision metrics.

In one embodiment, the hosted application service is a hosted Internet Talk Radio System and its hosted multi-party talk radio shows. The clients may be hosts, callers or listeners of the talk radio shows. The master servers are responsible for mixing the audio streams for the listeners, and routing the mixed and non-mixed audio streams to the listeners and callers accordingly.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, including the directory, master and slave servers, in accordance with one embodiment;

FIG. 2 illustrates the method of the present invention, in accordance with one embodiment;

FIG. 3 illustrates an overview of an application of the present invention to Internet Talk Radios;

FIG. 4 illustrates the method of the present invention as applied to Internet Talk Radios; and

FIG. 5 illustrates an internal component view of a computer system suitable for use to practice the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented in terms of operations performed by a processor based device, using terms such as data, tables, accepting, determining, inquiring, notifying, caching, routing, loading, and the like, consistent with the manner commonly employed by those skilled in the art to convey the substance of their work to others skilled in the art. As well understood by those skilled in the art, the quantities take the form of electrical, magnetic, or optical signals capable of being stored, transferred, combined, and otherwise manipulated through mechanical and electrical components of the processor based device; and the term processor include microprocessors, micro-controllers, digital signal processors, and the like, that are standalone, adjunct or embedded.

Various operations will be described as multiple discrete steps in turn, in a manner that is most helpful in understanding the present invention, however, the order of description should not be construed as to imply that these operations are necessarily order dependent. In particular, these operations need not be performed in the order of presentation. Further, the description repeatedly uses the phrase “in one embodiment”, which ordinarily does not refer to the same embodiment, although it may.

### Overview

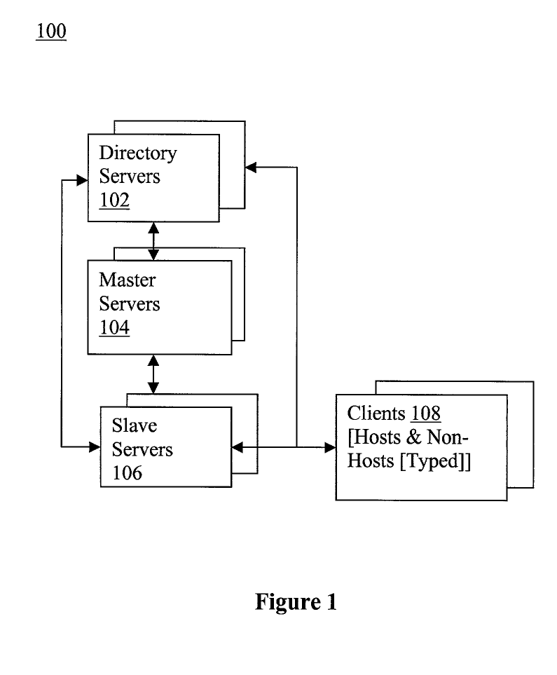

Referring now to FIG. 1, wherein a block diagram illustrating an overview of the present invention, including the directory, master and slave servers, in accordance with one embodiment, is shown. As illustrated, a number of directory servers 102, a number of master servers 104, and a number slave servers 106 are scalably coupled to each other in accordance with the present invention to host one or more application services and facilitate accesses to these one or more hosted application services by clients 108. As will be readily apparent from the description to follow, servers 102, 104 and 106 are advantageously coupled together in a scalable manner to allow only a necessary amount of these resources to be deployed to host the one or more application services, and additional resources be gradually and easily added as the application services, the instantiations and/or user bases of the hosted application services grow. For ease of understanding, the term “application service” will be used in its plural form, however unless otherwise specifically stated, each usage is to include its singular form. That is, the present invention may be practiced to host one or more application services.

Master servers 104 are employed to host the application services of interest, which may be any one of a variety of application services known in the art, including but are not limited to an Internet Talk Radio System, and its hosted multiparty talk radio shows. Master servers 104 host application services as instructed by directory servers 102. Master servers 104 are non-exclusively engaged with the directory servers 102 to host these application services, to be described more full below.

Slave servers 106 are employed to facilitate accesses by clients 108 to the application services hosted by master servers 104. That is, all communications or interactions between the hosted application services on master servers 104 and clients 108 are made through slave servers 106. Slave servers 106 are informed of the hosts of the application services (i.e. master servers 104) as well as clients 108, the slave servers 106 are to facilitate accesses. The information is provided to slave servers 106 by directory servers 102. Similar to master servers 104, slave servers 106 are not exclusively engaged with the directory servers 102 to facilitate accesses to the hosted application services, also to be described more full below.

Clients 108 request for accesses to the hosted application services with directory servers 102, and are informed of the slave servers 102 through which clients 108 are to make the accesses. Depending of the type of application services, such as the earlier mentioned Internet Talk Radio System, clients 108 may be divided into classes and their accesses to the hosted application services may be facilitated in accordance with their class memberships. For example, for the Internet Talk Radio application, access to a talk radio show of by a client 102 may be facilitated depending on whether the client is a host of the talk radio show, a listener of the talk radio show or a caller of the talk radio show. [Note the term “host” is used in at least two contexts, a first context where a master server 104 “hosts” an application service, and a second context where a client 108 “hosts” a talk radio show (which itself programmatically speaking is “hosted” by a master server 104).]

Except for logic to be provided to the various servers 102-106 and clients 108 to enable these devices to cooperate and interact with one another to enable the relatively easy and scalable expansion and contraction of server resources in proportion to the amount of application services and clients 108 supported, servers 102-106 and clients 108 are otherwise intended to represent a broad range of these servers/devices known in the art. Example systems suitable for use as servers 102-106 include but are not limited to servers of various capacities available from IBM of Armonk, N.Y., and Sun Microsystems of Menlo Park, Calif. Example systems/devices suitable for use as clients 108 include but are not limited to desktop/notebook sized computers from Dell Computer of Austin Tex., and Apple Computers of Cupertino, Calif., as well as various palm sized personal digital assistants from Palm Computing of San Jose, Calif., and Hewlett Packard of Palo Alto, Calif.

### Method

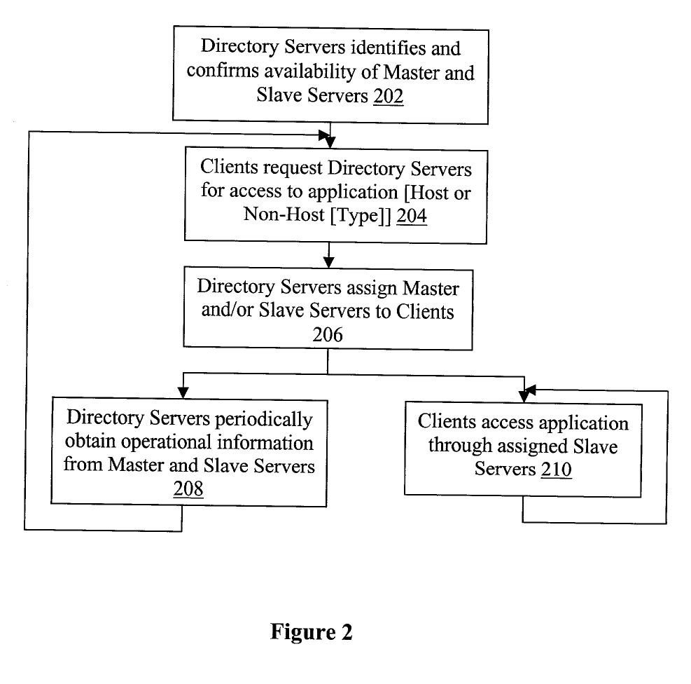

Referring now to FIG. 2, wherein a block diagram illustrating the method of the present invention, in accordance with one embodiment, is shown. As illustrated, during initialization of a directory server 102 (which is performed independent of one another), the initializing directory server 102 identifies and confirms the availability of the master and slave servers 104 and 106 available to its direction. In one embodiment, the list of nominally and non-exclusively available master and slave servers 104 and 106 are provided to an initializing directory server 102 by way of a configuration file. The configuration file includes the identities of these candidate master and slave servers 104 and 106 as well as the manner through which the master and slave servers 104 and 106 may be contacted/addressed, e.g. their IP addresses. The information may be organized in the configuration file in any convenient manner. An initializing directory server 102 reads and processes this configuration file during initialization upon power up or reset.

In one embodiment, an initializing directory server 102 confirms the nominal non-exclusive availability of the listed master and slave servers 104-106 by “pinging” each of the listed servers with a message to solicit a response from these servers to confirm their respective presence and nominal non-exclusive availability. The “pinging” and replying may be performed in any one of a number of networking discovery protocols known in the art, including but are not limited to DHCP.

Note that the present invention provides for each initializing directory server 102 to confirm the engagement of master and slave severs 104-106 independently without consultation or coordination with other directory servers 102, and the engagements are on a non-exclusive basis. Accordingly, some or all of the master and slave servers 104-106, unless purposely segregated or segmented by the network administrators, may engage and “service” applications/clients under the direction of multiple directory servers 102. However, as will be described in more detail below, the present invention provides for directory servers 102 to take into account any overlapped engagements, when performing selections and assignments of master and slave servers 104-106. Thus, the desired ease of expansion and contraction, i.e. scalability, may be provided.

Continuing to refer to FIG. 2, having nominally confirmed the availability of the master and slave servers 104 and 106 available for its direction, directory servers 102 await for clients requests for accesses to the hosted application services. In due course, one or more clients 108 make the access requests, block 204. In one embodiment, clients 108 make the access requests by accessing web pages hosted by a front end load balancer (not shown) of directory servers 102 and selecting the appropriate options provided on the web pages. The manner in which the web pages are organized or the manner in which the options are provided thereon, as well as the manner in which the front end load balancer selects directory servers 102 are not essential to the practice of the present invention. They may be organized, provided and selected in any manner.

In response, a selected directory server 102 selects and assigns the appropriate slave server 106 to facilitate the requesting client 108 to access the request application service, and if the application service has not been instantiated, the directory server 102 also selects and assigns the appropriate master server 104 to host the requested application service, block 206. As part of the selection and assignment process, client 108 is notified of the selected slave server 106, in particular, the manner though which the selected slave server 106 is to be contacted, e.g. its IP address. Similarly, the selected slave server 106 is notified of the assignment of client 108, and the master server 104 hosting the application service to be accessed by assigned client 108, e.g. their respective IP addresses. Of course if the application service is not already hosted by master server 104, it is also instructed to instantiate and start hosting of another instantiation or session of the requested application service.

In one embodiment, each directory server 102 performs the selections and assignments of master and slave servers 104 and 106 in accordance with a number of decision metrics that convey the ability of the non-exclusively engaged master and slave servers 104 and 106 to further undertake additional hosting of application services or facilitating access to hosted application services, in view of the hosting and facilitating already undertaken. In one embodiment, these decision metrics include the processing resources (as measured in e.g. the amount of instructions the master/slave server 104/106 is capable of executing per time unit, the amount of memory resources available and so forth), the number of application services and/or sessions already hosting, and the number of clients already facilitating.

In one embodiment, to enable each directory server 102 to perform the selections and assignments in accordance with the decision metrics, each directory server 102 periodically polls the non-exclusively engaged master and slave severs 104 and 106 for information related to the decision metrics, block 208. The polling and reply may be accomplished using any one of a number of messaging protocols. In one embodiment, each directory server 102 also caches the information collected. The cache data may be organized and stored in any one of a number of data structure and data storage techniques known in the art.

Back at block 206, upon notified of their responsibilities to host application services or facilitate access to hosted application services, master and slave servers 104 and 106 host the application services and facilitate client accesses accordingly. Similarly, upon notified of slave servers 106 to contact, clients 108 access the desired application services through assigned slave servers 106 accordingly, block 210.

Thus, it can be seen from the above description, by virtue of the substantially independent and yet indirectly coordinated direction of the master and slave servers, under the present invention, directory, master and slave servers 102-106 may be added or removed as the number of application services to be hosted increases or decreases or as the user bases of the hosted application services increases or decreases.

### Example Application—Internet Talk Radio

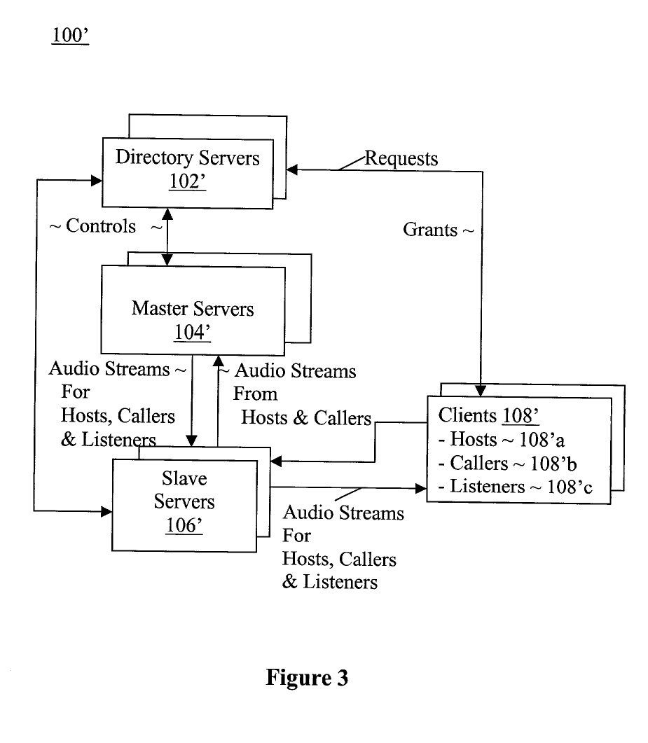

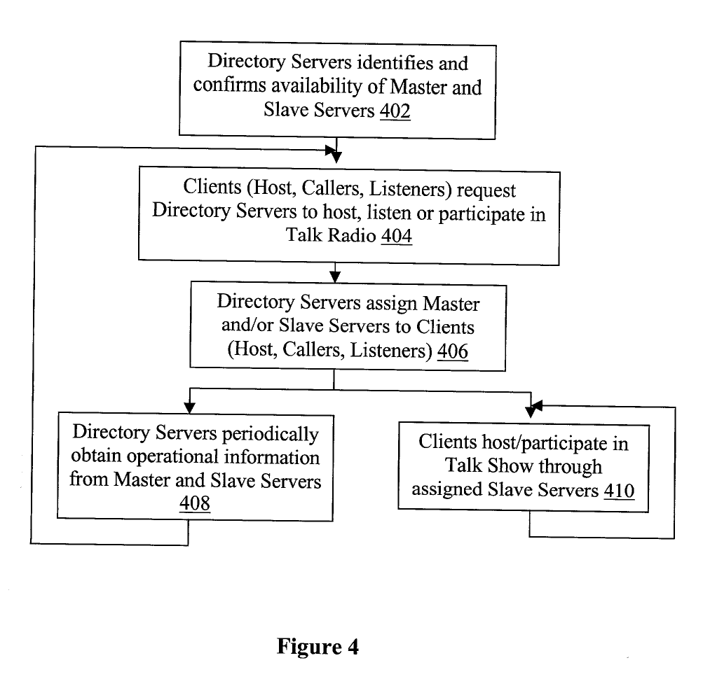

Referring now to FIGS. 3-4, wherein two block diagrams illustrating the system and method of FIGS. 1-2 as applied to an Internet Talk Radio application, in accordance with one embodiment, are shown. In other words, for the embodiment, at least clients 108′ are coupled to directory servers 102′ and slave servers 106′ through a public network, such as the Internet. Directory servers 102′, master servers 104′ and slave servers 106′ may be coupled to each other through public or private networks or combination thereof. The application services hosted by master servers 104′ include hosted multi-party packet based talk radio shows (commonly referred to as Internet Talk Radio). Thus, clients 108′ may be hosts 108′a, callers 108′b or listeners 108′c of the various talk radio shows of the hosted Internet Talk Radio System.

For the illustrated embodiment, as part of their responsibilities for hosting the talk radio shows of the Internet Talk Radio System, master servers 104′ are responsible for mixing the audio streams of the various talk radio shows received from callers 108′b of the various talk radio shows through their respective slave servers 106′ for listeners 108′c of the corresponding talk radio shows. Further, master servers 104′ are responsible for routing the mixed and non-mixed audio streams to callers 108′b and listeners 108′c of the various talk radio shows accordingly.

At block 402, the initialization of directory server 102′ and the confirmation of the availability of master and slave servers 104′ and 106′ under their respective directions are performed as earlier described. Thereafter, at block 404, client hosts 108′a of talk shows make their respective requests to directory servers 102′ to have their respective talk shows hosted. Obviously, a talk show has to be hosted before any caller 108′b or listener 108′c may join the talk show. However, the different talk shows may be instantiated at different times. Some talk shows may be instantiated while others are already in progress. In like manner, client callers 108′b and listeners 108′c make their respective requests to directory servers 102′ to join the talk shows of interest. Both the request to host a new talk show and the request to join a talk show in progress may be made through the employment of web pages and a front end load balancer as earlier described.

At block 406, directory servers 102′ respond to the requests to host new talk shows and requests to join talk shows of interest as earlier described. That is, directory servers 102′ select and assign slave servers 106′ to requesting clients 108′ for them to access the appropriate master servers 104′ to host/participate in the talk shows of interest. Further, if applicable, directory servers 102′ select and assign master servers 104′ to host the talk shows. Directory servers 102′ notify clients 108′, master and slave servers 104′-106′ accordingly. Directory servers 102′ perform the selections and assignments in accordance with a number of decision metrics as earlier discovered. Further directory servers 102′ periodically poll master and slave servers 104′ and 106′ for information related to the decision metrics as earlier described, block 408.

Upon assigned the responsibilities, at block 406, master and slave servers 104′ and 106′ perform their respective hosting and facilitating access accordingly, whereas at block 410, clients 108′ host, call or otherwise listen to the talk shows of interest accordingly. More specifically, client hosts 108′a submit controls to master servers 104′ hosting their respective talk shows through their assigned slave servers 106′. Upon receipt of these controls, slave servers 106′ route the controls to the appropriate master servers 104′. Similarly, client callers 108′c participate in the talk shows of interest, sending their audio streams to master servers 104′ through slave servers 106′. Upon receipt of the audio streams of the various talk radio shows, slave servers 106′ route the audio streams of the various talk radio shows to the appropriate master servers 104′ accordingly.

For the embodiment, master servers 104′, upon receipt of the audio streams of their hosted talk radio shows, cause the audio streams of the different callers of each hosted talk radio show to be routed to the other callers (through their respective slave servers 106′) of the talk radio show. That is, if a talk radio show has callers A, B and C, the audio stream of caller A is routed to callers B and C, the audio stream of caller B is routed to caller C and A, and so forth. Further, master servers 104′ mix the different audio streams of a talk radio show to generate a mixed audio stream for the talk radio show, and route the mixed audio stream of the talk radio show to the client listeners 108′c of the talk radio show.

As alluded to earlier, upon received of audio streams of the various talk radio shows from master servers 104′, mixed or non-mixed, slave servers 106′ route the audio streams of the various talk radio shows to the client callers 108′b and the client listeners 108′c of the various talk radio shows as appropriate.

Thus, an Internet Radio Talk System may be advantageously hosted in scalable manner, allowing resources to be gradually increased as more shows are being hosted, or more callers/listeners are “dialing” in to the hosted shows.

Example Computer System

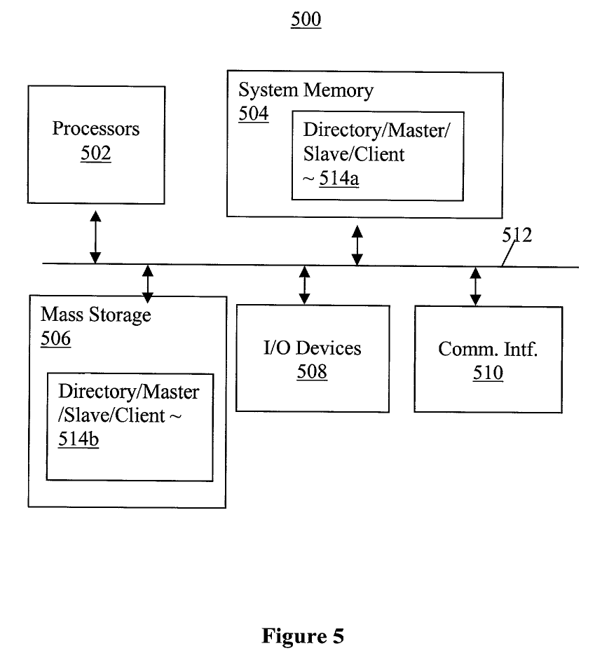

FIG. 5 illustrates an example computer system suitable for use as a directory server, a master server, a slave server or a client device, in accordance with one embodiment. As shown, computer system 500 includes one or more processors 502 and system memory 504. Obviously, more processing power and memory capacity should be provided if computer system 500 is used as a directory server 102 or a master server 104, and less processing power and memory capacity may be provided if computer system 500 is used as a slave server 106 or a client system 108. Additionally, computer system 500 includes mass storage devices 506 (such as diskette, hard drive, CDROM and so forth), input/output devices 508 (such as keyboard, cursor control and so forth) and communication interfaces 510 (such as network interface cards, modems and so forth). The elements are coupled to each other via system bus 512, which represents one or more buses. In the case of multiple buses, they are bridged by one or more bus bridges (not shown). Each of these elements performs its conventional functions known in the art. In particular, system memory 504 and mass storage 506 are employed to store a working copy and a permanent copy of the programming instructions implementing the directory server, master server, slave server or the cleint logic of the present invention. The permanent copy of the programming instructions may be loaded into mass storage 506 in the factory, or in the field, as described earlier, through a distribution medium (not shown) or through communication interface 510 (from a distribution server (not shown). The constitution of these elements 502-512 are known, and accordingly will not be further described.

### Conclusion and Epilog

Thus, an improved method and apparatus for scalably hosting application services, in particular an Internet Talk Radio System and its hosted talk radio shows, has been described. While the present invention has been described in terms of the above illustrated embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A method comprising:
each of a plurality of directory servers non-exclusively engaging a first plurality of servers to serve as master servers for hosting one or more application services, and a second plurality of servers to serve as slave servers for facilitating clients accesses to the hosted one or more application services;
the directory servers receiving requests from clients to access a selected one or selected ones of said one or more application services; and
the directory servers selecting and assigning selected ones of their non-exclusively engaged master servers to host said accessed application service or services as well as selecting and assigning selected ones of their engaged slave servers to facilitate said clients to access said hosted application service or services.

2. The method of claim 1, wherein at least some of the master and slave servers are engaged to host application service or services, and facilitate clients accesses for multiple ones of said directory servers, and the directory servers perform said selections and assignments of master and slave servers to host application service or services and facilitate accesses to the hosted application service or services based on a plurality of operational metrics that directly or indirectly convey the master and slave servers ability to further host additional instantiation of an application service or additional application service, and facilitate clients accesses, in view of the hosting and access facilitating respectively already undertaken by the non-exclusively engaged master and slave servers.

3. The method of claim 2, wherein said method further comprises the directory servers periodically polling their non-exclusively engaged master and slave servers for information related to said operational metrics the directory servers employed to select and assign master and slave servers to host one or more application services and facilitate accesses to the one or more hosted application services.

4. The method of claim 1, wherein at least said clients are coupled to said directory and slave servers through a public network, and said hosted one or more application services include a packet based talk radio system and its hosted multi-party talk radio shows, with said clients comprising hosts, listeners and callers of said hosted multi-party talk radio shows.

5. In a directory server, a method comprising:
contacting a first plurality of other servers to non-exclusively engage said first plurality of other servers to serve as master servers for hosting one or more application services;
contacting a second plurality of other servers to non-exclusively engage said second plurality of other servers to serve as slave servers for facilitating clients accesses to one or more hosted application services;
receiving requests from clients to access a selected one or selected ones of said one or more hosted application services; and
selecting and assigning selected ones of said non-exclusively engaged master servers to host said one or more accessed application services as well as selecting and assigning selected ones of said non-exclusively engaged slave servers to facilitate said clients to access said one or more hosted application services.

6. The method of claim 5, wherein said selections and assignments of non-exclusively engaged master and slave servers to host one or more application services and facilitate accesses to the one or more hosted application services are performed in accordance with a plurality of operational metrics that directly or indirectly convey the master and slave servers ability to further host an additional instantiation of an application service or additional application services, and facilitate client accesses, in view of the hosting and access facilitating respectively already undertaken by the non-exclusively engaged master and slave servers.

7. The method of claim 6, wherein said method further comprises periodically polling said non-exclusively engaged master and slave servers for information related to said operational metrics employed to select and assign master and slave servers to host one or more application services and facilitate accesses to the one or more hosted application services.

8. The method of claim 5, wherein at least said clients are coupled to said directory and slave servers through a public network, and said one or more hosted application services include a packet based talk radio system and its hosted multi-party talk radio shows, with said clients comprising hosts, listeners and callers of said hosted multi-party talk radio shows.

9. An apparatus comprising:
storage medium having stored therein a plurality of programming instructions designed to operate the apparatus to
contact a first plurality of other apparatuses to non-exclusively engage said first plurality of other apparatuses to serve as master servers for hosting one or more application services,
contact a second plurality of other apparatuses to non-exclusively engage said second plurality of other apparatuses to serve as slave servers for facilitating clients accesses to one or more hosted application services,
receive requests from clients to access selected ones of said one or more hosted application services; and
select and assign selected ones of said non-exclusively engaged master servers to host said accessed application service or services as well as select and assign selected ones of said non-exclusively engaged slave servers to facilitate said clients to access said one or more hosted application services; and
at least one processor coupled to the storage medium to execute the programming instructions.

10. The apparatus of claim 9, wherein said programming instructions are further designed to operate the apparatus to perform said selections and assignments of non-exclusively engaged master and slave servers to host one or more application services and facilitate accesses to the hosted application service or services in accordance with a plurality of operational metrics that directly or indirectly convey the master and slave servers ability to further host additional instantiations of an application service or additional application services, and facilitate clients accesses, in view of the hosting and access facilitating respectively already undertaken by the non-exclusively engaged master and slave servers.

11. The apparatus of claim 9, wherein said programming instructions are further designed to operate the apparatus to periodically poll said non-exclusively engaged master and slave servers for information related to said operational metrics employed to select and assign master and slave servers to host one or more application services and facilitate accesses to the one or more hosted application services.

12. The apparatus of claim 9, wherein at least said clients are coupled to said apparatus and said slave servers through a public network, and said one or more hosted application services include a packet based talk radio system and its hosted multi-party talk radio shows, with said clients comprising hosts, listeners and callers of said hosted multi-party talk radio shows.

13. In a master server, a method comprising:
consenting to non-exclusive engagements to serve as a master server for hosting one or more application services for a plurality of directory servers;
receiving instructions from the plurality of directory servers to host a selected one or selected ones of said one or more hosted application services; and
hosting said selected one or ones of said one or more hosted application services accordingly.

14. The method of claim 13, wherein said method further comprises responding to periodically polling by said directory servers for information related to operational metrics employed by said directory servers to select and assign master servers to host one or more application services.

15. The method of claim 13, wherein said method further comprises interacting with a plurality of slave servers to facilitate access by clients to said one or more hosted application services, said clients accessing said one or more hosted application services through said slave servers.

16. The method of claim 13, wherein said clients are coupled to said directory servers through a public network, and said one or more hosted application services include a packet based talk radio system and its hosted multi-party talk radio shows, with said clients comprising hosts, listeners and callers of said hosted multi-party talk radio shows.

17. The method of claim 16, wherein said hosting of said packet based talk radio show and its said hosted multi-party talk radio shows comprises receiving audio streams of a plurality of callers of a hosted multi-party talk radio show through one or more slave servers through which said callers access said hosted multi-party talk radio show, said callers being coupled to said one or more slave servers through said public network.

18. The method of claim 16, wherein said hosting of said packet based talk radio system and said hosted multi-party talk radio shows further comprises mixing received audio streams to generate a mixed audio stream, and sending said mixed audio stream to listeners of said multi-party talk radio show through one or more slave servers through which said listeners access said hosted multi-party talk radio show, said listeners being coupled to said one or more slave servers through said public network.

19. The method of claim 16, wherein said hosting of said packet based talk radio system and said hosted multi-party packet based talk radio shows further comprises sending a first audio stream received through a first slave server from a first caller to a second caller through a second slave server, and sending a second audio stream received through said second slave server from said second caller to said first caller through said first slave server, said first and second callers being coupled to said first and second slave servers through said public network.

20. The method of claim 19, wherein said first and second slave servers are one of the same slave server.

21. An apparatus comprising:
storage medium having stored therein a plurality of programming instructions designed to operate the apparatus to
consent to non-exclusive engagements to serve as a master server for hosting one or more application services for a plurality of directory servers coupled to said apparatus,
receive instructions from the plurality of directory servers to host a selected one or selected ones of said one or more hosted application services, and
host said selected one or ones of said one or more hosted application services accordingly; and
at least one processor coupled to the storage medium to execute the programming instructions.

22. The apparatus of claim 21, wherein said programming instructions are further designed to operate the apparatus respond to periodically polling by said directory servers for information related to operational metrics employed by said directory servers to select and assign master servers to host one or more application services.

23. The apparatus of claim 21, wherein said programming instructions are further designed to operate the apparatus to interact with a plurality of slave servers coupled to the apparatus to facilitate access by clients to said one or more hosted application services, said clients accessing said one or more hosted application services through said slave servers.

24. The apparatus of claim 23, wherein said clients are coupled to said directory servers through a public network, and said hosted one or more application services include a packet based talk radio system and its hosted multi-party talk radio shows, with said clients comprising hosts, listeners and callers of said hosted multi-party talk radio shows.

25. The apparatus of claim 24, wherein said programming instructions are further designed to receive audio streams of a plurality of callers of a hosted multi-party packet based talk radio show through one or more slave servers through which said callers access said hosted multi-party packet based talk radio show, said callers being coupled to said one or more slave servers through said public network.

26. The apparatus of claim 24, wherein said programming instructions are further designed to operate the apparatus to mix received audio streams to generate a mixed audio stream, and to send said mixed audio stream to listeners of said multi-party talk radio show through one or more slave servers through which said listeners access said hosted multi-party packet based talk radio show, said listeners being coupled to said slave servers through said public network.

27. The apparatus of claim 24, wherein said programming instructions are further designed to send a first audio stream received through a first slave server from a first caller to a second caller through a second slave server, and to send a second audio stream received through said second slave server from said second caller to said first caller through said first slave server, said first and second callers are coupled to said first and second slave servers through said public network.

28. The apparatus of claim 27, wherein said first and second slave servers are one of the same slave server.

29. In a slave server, a method comprising:
consenting to non-exclusive engagements to serve as a slave server for facilitating clients accesses to one or more hosted application services for a plurality of directory servers;
receiving instructions from the plurality of directory servers to facilitate accesses by clients to a selected one or selected ones of said one or more hosted application services; and
facilitating accesses by clients to said selected one or ones of said one or more hosted application services accordingly.

30. The method of claim 29, wherein said method further comprises responding to periodically polling by said directory servers for information related to operational metrics employed by said directory servers to select and assign slave servers to facilitate clients accesses to one or more hosted application services.

31. The method of claim 29, wherein said method further comprises interacting with a plurality of master servers to facilitate accesses by clients to one or more application services hosted by said master servers.

32. The method of claim 29, wherein said clients are coupled to said directory and slave servers through a public network, and said one or more hosted application services include a packet based talk radio system and its hosted multi-party talk radio shows, with said clients comprising hosts, listeners and callers of said hosted multi-party talk radio shows.

33. The method of claim 32, wherein said facilitating of access to said hosted multi-party packet based talk radio shows comprises receiving audio streams from a plurality of facilitated callers of a hosted multi-party talk radio show, and forwarding the received audio streams to a master server hosting said hosted multi-party talk radio show.

34. The method of claim 32, wherein said facilitating of access to said hosted multi-party packet based talk radio shows further comprises receiving a mixed audio stream from a master server hosting said hosted multi-party talk radio show, and sending said mixed audio stream to a plurality of listeners facilitated by the slave server to access said hosted multi-party packet based talk radio show.

35. The method of claim 32, wherein said facilitating of access to said hosted multi-party packet based talk radio shows further comprises receiving a first and a second audio stream of a hosted multi-party packet based talk radio show from a master server hosting said hosted multi-party packet based talk radio show, provided to said master server on behalf of a first and a second client, and sending said first and second audio streams to said second and first clients respectively.

36. An apparatus comprising:
storage medium having stored therein a plurality of programming instructions designed to operate the apparatus to
consent to non-exclusive engagements to serve as a slave server for a plurality of directory servers for facilitating clients coupled to said apparatus to access one or more hosted application services,
receive instructions from the plurality of directory servers to facilitate accesses by clients to a selected one or selected ones of said one or more hosted application services, and
facilitate accesses by clients to said selected one or ones of said one or more hosted application services accordingly; and
at least one processor coupled to the storage medium to execute the programming instructions.

37. The apparatus of claim 36, wherein said programming instructions are further designed to operate the apparatus to respond to periodic polling by said directory servers for information related to operational metrics employed by said directory servers to select and assign slave servers to facilitate clients accesses to one or more hosted application services.

38. The apparatus of claim 36, wherein said programming instructions are further designed to operate the apparatus to interact with a plurality of master servers to facilitate accesses by clients to one or more application services hosted by said master servers.

39. The apparatus of claim 36, wherein said clients are coupled to said apparatus and said directory servers through a public network, and said one or more hosted application services include a packet based talk radio system and its hosted multi-party packet based talk radio shows, with said clients comprising hosts, listeners and callers of said hosted multi-party talk radio shows.

40. The apparatus of claim 39, wherein said programming instructions are further designed to operate the apparatus to receive audio streams from a plurality of facilitated callers of a hosted multi-party packet based talk radio show, and to forward the received audio streams to a master server hosting said hosted multi-party packet based talk radio show, said master server being coupled to said apparatus.

41. The apparatus of claim 39, wherein said programming instructions are further designed to operate the apparatus to receive a mixed audio stream from a master server hosting said hosted multi-party packet based talk radio show, and to send said mixed audio stream to a plurality of listeners facilitated by the slave server to access said hosted multi-party talk radio show.

42. The apparatus of claim 39, wherein said programming instructions are further designed to operate the apparatus to receive a first and a second audio stream of said hosted multi-party packet based talk radio show from a master server hosting said hosted multi-party packet based talk radio show, provided to said master server on behalf of a first and a second caller, and to send said first and second audio streams to said second and first callers respectively.

43. In a client device, a method comprising:
requesting a directory server for access to a hosted application service;
receiving identification of a slave server from the directory server to access said hosted application service through said identified slave server; and
accessing said hosted application service hosted through said identified slave server accordingly.

44. The method of claim 43, wherein said client device is coupled to said directory and slave servers through a public network, and said hosted application service is a packet based talk radio system and a first of its hosted multi-party talk radio shows, with said client being one of a host, a listener or a caller of said first hosted multi-party talk radio show.

45. The method of claim 44, wherein said access of said first hosted multi-party talk radio show comprises providing control information to a master server hosting said first multi-party talk radio show, through said identified slave server, said client device being a host of said first hosted multi-party talk radio show.

46. The method of claim 44, wherein said access of said first hosted multi-party talk radio show comprises receiving audio streams of callers from a master server hosting said first multi-party talk radio show, through said identified slave server, said client device being a host of said first hosted multi-party talk radio show.

47. The method of claim 44, wherein said access of said first hosted multi-party talk radio show comprises receiving a mixed audio stream from a master server hosting said first multi-party talk radio show, through said identified slave server, said mixed audio stream being generated from audio streams of callers of said first hosted multi-party talk radio show received by said master server, and said client device being a listener of said first hosted multi-party talk radio show.

48. The method of claim 44, wherein said access of said first hosted multi-party talk radio show comprises receiving an audio stream from a master server hosting said first multi-party talk radio show, through said identified slave server, said audio stream being received from a caller of said first hosted multi-party talk radio show by said master server, and said client device being a caller of said first hosted multi-party talk radio show.

49. An apparatus comprising:
storage medium having stored therein a plurality of programming instructions designed to operate the apparatus to
request a directory server for access to a hosted application service,
receive identification of a slave server from the directory server to access said hosted application service hosted through said identified slave server, and
access said hosted application service through said identified slave server accordingly; and
a processor coupled to the storage medium to execute the programming instructions.

50. The apparatus of claim 49, wherein said apparatus is coupled to said directory and slave servers through a public network, and said hosted application service is a packet based talk radio system and a first of its hosted multi-party talk radio shows, with said client being one of a host, a listener or a caller of said first hosted multi-party talk radio show.

51. The apparatus of claim 50, wherein said programming instructions are designed to operate the apparatus to provide control information to a master server hosting said first multi-party talk radio show, through said identified slave server, said apparatus being a host of said first hosted multi-party talk radio show.

52. The apparatus of claim 50, wherein said programming instructions are designed to operate the apparatus to receive audio streams of callers from a master server hosting said first multi-party talk radio show, through said identified slave server, said apparatus being a host of said first hosted multi-party talk radio show.

53. The apparatus of claim 50, wherein said programming instructions are designed to operate the apparatus to receive a mixed audio stream from a master server hosting said first multi-party talk radio show, through said identified slave server, said mixed audio stream being generated from audio streams of callers of said first hosted multi-party talk radio show received by said master server, and said apparatus being a listener of said first hosted multi-party talk radio show.

54. The apparatus of claim 50, wherein said programming instructions are designed to operate the apparatus to receive an audio stream from a master server hosting said first multi-party talk radio show, through said identified slave server, said audio stream being received from a caller of said first hosted multi-party talk radio show by said master server, and said apparatus being a caller of said first hosted multi-party talk radio show.
